(19) United States
(12) Patent Application Publication
(10) Pub. No.: US 2026/0195779 A1
(43) Pub. Date: Jul. 9, 2026

(54) Fractional Storage of Intermediate Results for Efficient Re-computation of Nonlinear Analyses of Large Datasets

(71) Applicant: Woven Data, Inc., San Francisco, CA (US)

(72) Inventors: Sergei Krupenin, San Francisco, CA (US); Andrei Kolodovski, San Francisco, CA (US); Scott Hoffman, Newtown Square, PA (US)

(21) Appl. No.: 19/063,550

(22) Filed: Feb. 26, 2025

Related U.S. Application Data
(60) Provisional application No. 63/741,501, filed on Jan. 3, 2025.

(51) Int. Cl. G06Q 30/0201

(52) U.S. Cl. CPC G06Q 30/0201

(57) ABSTRACT

Methods are provided for efficient re-computation of outputs based on large numbers of input samples. The computations include the computation of a static (or substantially static) gating or eligibility function that determines whether a sample is included in a particular computation (e.g., sum, average, weighted average). The gating function can be nonlinear and depend on multiple inputs. The gating function is pre-computed and the result saved for re-use, thereby reducing the computational costs of re-performing the computation (e.g., with modified weightings or other modifications) by allowing the gating function to be assessed by retrieving the previously stored gating function results, rather than re-computing them. These methods find use in a variety of applications, including the performance of regulatory compliance computations and audits thereof, e.g., pharmaceutical manufacturers analyzing sales and pricing data to generate average per-units costs or other analyses of large numbers of gated samples.

### CROSS-REFERENCE TO RELATED APPLICATION

This application claims priority to U.S. Provisional Patent Application No. 63/741,501, filed on Jan. 3, 2025, the contents of which are hereby incorporated by reference in their entirety.

### BACKGROUND

In many applications, the performance of a computation or other analysis includes performing, for each element of a dataset (e.g., measurement of a physical property, transaction, pixel), a variety of linear or nonlinear computations based on one or more underlying variables. For example, determining an overall amount of CO₂ emitted by all measured CO₂ sources in a geographical region across a particular period of time could include, for each direct or indirect CO₂ measurement recorded in a database, 1) determining whether the measurement is eligible for the computation, i.e., whether the measurement corresponds to the geographical region and period of time, and 2) if the first determination is positive, performing some other computation (e.g., applying a calibration or offset, adding the measurement to a cumulative sum of CO₂). Each such measurement or other sample in such a computation may implicate both processor, memory, and other costs related to a calculation (e.g., the performance of nonlinear function on a set of input data to determine eligibility) as well as other computational costs to retrieve the relevant data from storage (e.g., database calls to multiple different tables, databases, or other data storage elements to accumulate all of the antecedent information for the calculation). These factors can lead to significant computational costs and latency when performing such analyses on very large datasets, even when the calculation for any individual element of the dataset is computationally inexpensive.

### SUMMARY

In a first aspect, a method for efficiently re-executing computations on large datasets is provided that includes: (i) for each sample of a dataset, evaluating a gating function and storing the result; (ii) performing a first computation with respect to the dataset, wherein performing the first computation with respect to the dataset comprises: (a) retrieving the stored gating function results for a first subset of the samples of the dataset, and (b) using those

samples of the first subset whose retrieved gating function results are positive to evaluate a first calculation; and (iii) subsequent to performing the first computation, performing a second computation with respect to the dataset, wherein performing the second computation with respect to the dataset comprises: (a) retrieving the stored gating function results for a second subset of the samples of the dataset, and (b) using those samples of the second subset whose retrieved gating function results are positive to evaluate a second calculation, wherein the second calculation differs from the first calculation.

In another aspect, a non-transitory computer readable medium is provided having stored thereon program instructions executable by at least one processor to cause the at least one processor to perform the above method.

In another aspect a system is provided that includes: (i) at least one processor; and (ii) a non-transitory computer-readable medium, having stored therein instructions executable by the at least one processor to cause the system to perform the above method.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation

### BRIEF DESCRIPTION OF THE FIGURES

FIG. 1 illustrates aspects of a data storage system, in accordance with example embodiments.

FIG. 2 illustrates aspects of a data storage system, in accordance with example embodiments.

FIG. 3A illustrates aspects of a method, in accordance with example embodiments.

FIG. 3B illustrates aspects of a method, in accordance with example embodiments.

FIG. 3C illustrates aspects of a method, in accordance with example embodiments.

FIG. 4 illustrates aspects of a method, in accordance with example embodiments

FIG. 5 illustrates aspects of an example system.

FIG. 6 illustrates a flowchart of an example method.

### DETAILED DESCRIPTION

### I. Overview

In many data analysis and computational applications, performing a particular computation can involve performing operations on a very large number of samples. For example, physical measurements or other samples at a plurality of points in time (e.g., once or more per second) from a plurality of measurement sites/sources (e.g., measuring stations distributed at many locations across a region to be monitored), pixels of an image, or transactions in a point of sale, payment processor, or other database of financial transactions could be used as the basis of such a computation. Some aspect(s) of such a set of samples could be used directly for the computation of interest, e.g., a measured amount of emitted carbon dioxide could be added to a running sum to determine a total amount of carbon dioxide emitted from a region, an amount and number of units of a transaction could be added to respective sunning sums to determine the total number of units and total cost of a set of transaction, etc.

Other aspect(s), however, could be used to determine whether to use a sample at all in the computation, i.e., to gate the sample for use in a particular calculation or otherwise assess the validity of the sample for the computation. For example, for a computation of the amount of carbon dioxide emitted from gas-burning power plants within a specified region (e.g., a state) within a specified period of time (e.g., a particular calendar year), each sample could be assessed as to whether it corresponded to the correct type of power plant in the correct region and from the correct time period before adding it to a cumulative sum of emitted carbon dioxide or otherwise using the sample for a calculation. In another example, each sample could represent a transaction in pharmaceuticals (e.g., a transaction amount and number of units sold) and could be characterized by drug identity, drug type, customer type, contract type, transaction type, or other information and the performance of certain calculations (e.g., determination of average unit price for one or more drugs for regulatory or reimbursement reasons) could be keyed to certain drugs, types of drugs, customers, types of contract, types of transaction, etc. such that the transactions must be correspondingly gated before using the computation-eligible data appoints to perform the calculation. Such eligibility determinations can also include determining whether a sample is likely to be inaccurate, mis-calibrated, duplicate of another sample, or otherwise not eligible for use in a particular calculation.

In many such applications, it can be desirable to re-compute a particular computation, potentially many times. For example, it could be desirable to repeatedly adjust aspects of a computation (e.g., an amount of carbon dioxide emitted, a price of a drug, an amount of rebate provided to certain customers when purchasing a drug) in order to determine the underlying cause of an observed change in the result of the computation (e.g., to determine why an average drug price has changed) and/or to determine which of a number of possible interventions should be used to obtain a desired result. In such examples, it can be desirable to reduce the latency of the re-computation in order to allow a human user to quickly evaluate the effects on the calculation of changes thereto (e.g., as the user moves a slider to adjust a level of scaling applied to a particular factor in the calculation) in real-time or near real-time. However, where such computations involve a large number (e.g., tens of thousands, millions) of samples, with corresponding amounts of computation and data retrieval costs (e.g., database calls) associated therewith, re-computation can take more time than is desirable, and may also implicate an undesirably high total computational cost (e.g., with respect to processor cycles, memory usage, interconnect bandwidth, database calls, power).

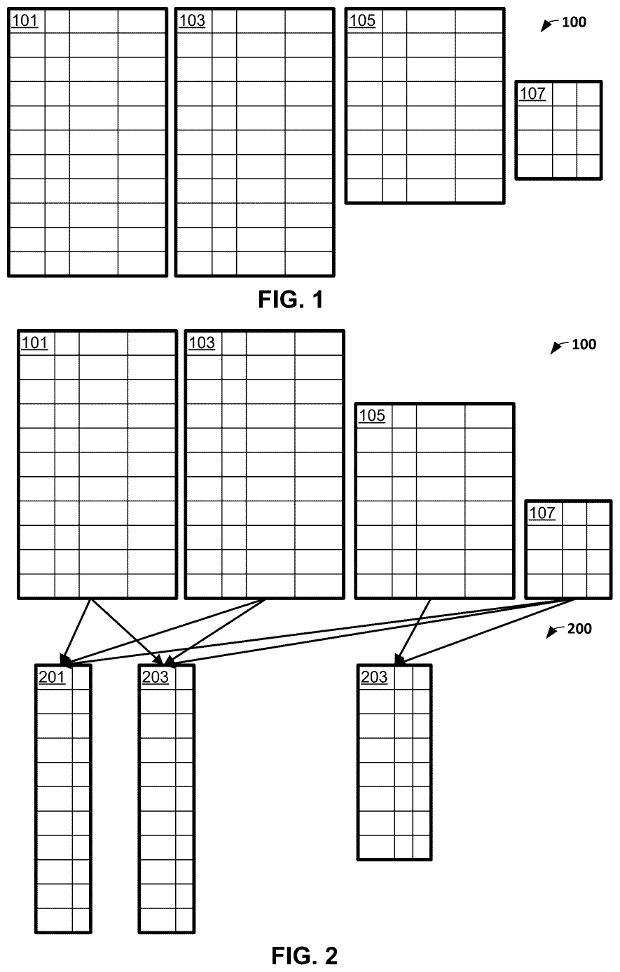

For example, FIG. 1 depicts a number of tables 101, 103, 105, 107 (e.g., in a database) that can be used to perform a computation as described herein. A particular sample could be represented by a row in a single table (e.g., table 105) or rows in multiple tables (e.g., tables 101 and 103). Further, to determine the eligibility of a particular sample for a particular computation, it could be necessary to call some auxiliary data source that contains lookup information (e.g., table 107 containing lookup tables to determine which drugs or classes of drugs and which geographical locations are eligible for performing one computation of a set of computations). Accordingly, determining the eligibility of a particular sample for a computation, and retrieving the information the information for eligible samples in order to perform one or more relevant calculations, can involve multiple database calls to multiple tables, the evaluation of linear or nonlinear gating functions to determine eligibility (e.g., to determine that each of one or more properties of the sample corresponds to respective sets of one or more eligible categories for a particular computation), the evaluation of linear or nonlinear calculations (e.g., to scale or calibrate a measurement or transaction amount prior to addition to a running sum or other aspect of a calculation from eligible samples).

The embodiments described herein advantageously reduce the latency and computational cost to re-compute computations by storing the results of the evaluation of the eligibility gating function across the set of samples. Thus, subsequent re-computations can exhibit significantly reduced computational costs by using the stored gating function results. This benefit is obtained since the factors underlying the determination of such gating functions (e.g., the location, contract type, customer type, drug ID or type, etc.) generally do not change for a given sample, nor are they generally modified by users in order to investigate the underlying mechanics of a particular dataset. Rather, re-computations generally vary from each other with respect to user-specified high-level adjustments (e.g., scaling factors applied to sales amounts or customer behaviors) and/or adjustments of non-gating-related aspects of the samples (e.g., a default per-unit sale price, a rebate amount provided to certain classes of customer). Accordingly, the results of the gating function evaluation can be stored and later re-used rather than being recalculated anew with each re-computation. This significantly reduces the computational cost of re-computation (e.g., with respect to processor cycles, database calls, bandwidth used between processors and data storage elements, memory use, power) as well as significantly reducing latency, facilitating realtime (or nearly realtime) re-computation even for large datasets (e.g., for transaction databases containing many thousands of transactions in a pharmaceuticals or other goods or services).

FIG. 2 depicts aspects of such a process, with the gating functions for samples represented in tables 101 and 103 stored in a first result table 201 and the gating functions for samples represented in table 105 stored in a second result table 203. The arrows indicate where source of data used to generate the gating functions for a particular table; as shown, the auxiliary table 107 was used (e.g., to lookup which categories with respect to different properties of the samples are or are not eligible) to determine the gating functions. Multiple gating function outputs can be pre-computed and stored for a particular set of samples. For example, table 203 stores second gating functions for the samples represented in tables 101 and 103. Such multiple different gating functions could correspond to eligibility of the samples for different computations, e.g., for eligibility for a first regulatory pricing computation (e.g., average manufacturer price, “AMP”) vs. a second, different regulatory pricing computation (e.g., average sales price, “ASP”).

As noted above, pre-computation of the gating function results for later retrieval and re-use can reduce the latency and computational cost of subsequent computations. Some of these benefits can be obtained by, as depicted in FIG. 2, storing the gating function results in a single table, reducing the bandwidth and database call costs of, e.g., polling multiple eligibility properties (e.g., location, customer type) from respective multiple different tables. Indeed, such benefits could be extended by, e.g., including in the single table additional non-gating information (e.g., transaction amounts, transaction units, transaction unit price) that can, for eligible samples, be used for a calculation, thereby further reducing the bandwidth and/or database calls required for re-computation. In some examples, the tables containing the pre-computed gating function results could be stored, with the underlying source data tables, according to a star schema or other database scheme. For example, the source data tables 101, 103, 105, 107 could be fact tables in a star schema, while the tables containing the gating functions derived therefrom could be dimension tables. When the underlying source data is updated in a manner that could result in a change in the stored, pre-computed gating function(s) (e.g., due to the geographical location of a particular sample having been mis-entered, and that error later detected and corrected), the stored gating function could be correspondingly updated. Thus, subsequent re-computations could proceed based on the updated, corrected gating function.

When retrieving such pre-computed gating function results for a computation, all samples whose gating functions are positive could be used as eligible samples for the computation. Note that the gating function of a sample being ‘positive’ only means that the gating function indicates eligibility for the relevant computation. It is not necessary for the gating function to have a mathematically positive (or even non-zero) value for the gating function to be eligible, and thus ‘positive’ for use in a calculation. Indeed the gating functions could be categorical variables (e.g., binary variables, with ‘positive’ being indicated by a ‘0’ or ‘1’ binary category value, according to an application) or some other values such that the stored gating functions can be readily used to indicate whether a particular sample is eligible for use in a particular computation.

Determining the gating function with respect to a particular sample could include assessing one or more properties of the sample (e.g., two or more properties of the sample). This could include comparing the one or more properties to corresponding one or more sets of valid values, categories, ranges or values, or other sets of valid values thereof to determine eligibility. The comparisons could be performed individually and independently, or could be performed across combinations of two more properties (e.g., such that the eligibility of a sample as a function of a first property depends on the value of one or more additional properties).

Properties of a sample that could be used to determine a gating function therefor could include a location of a transaction, a contract type of a transaction, an identity of a drug sold in a transaction, or a type of entity to whom a drug was sold in a transaction, or some other property of a transaction represented by the sample. Further, as noted above, multiple different gating functions could be determined for a set of samples (e.g., corresponding to eligibility with respect to respective different computations/calculations).

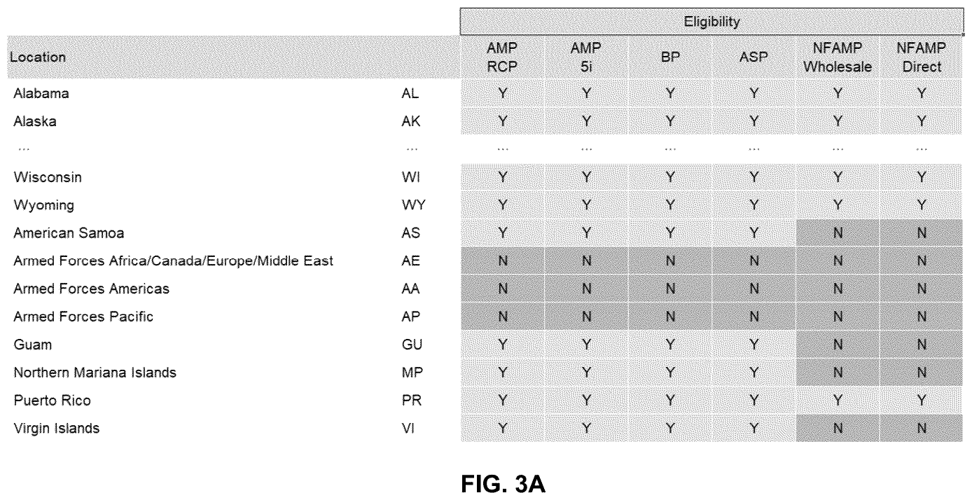

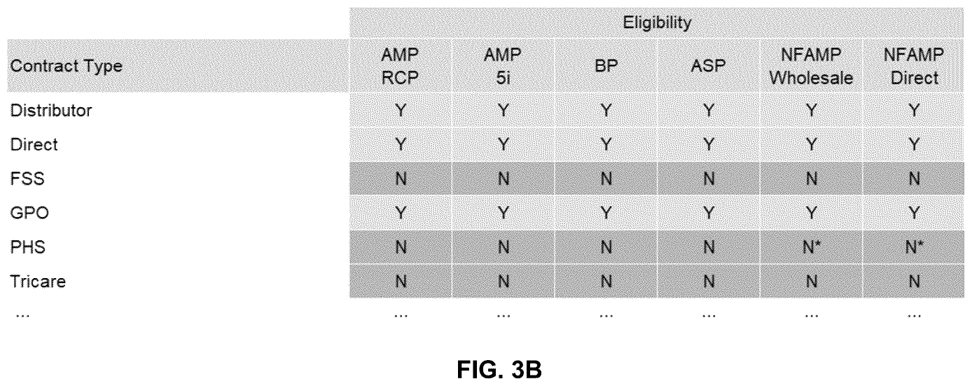

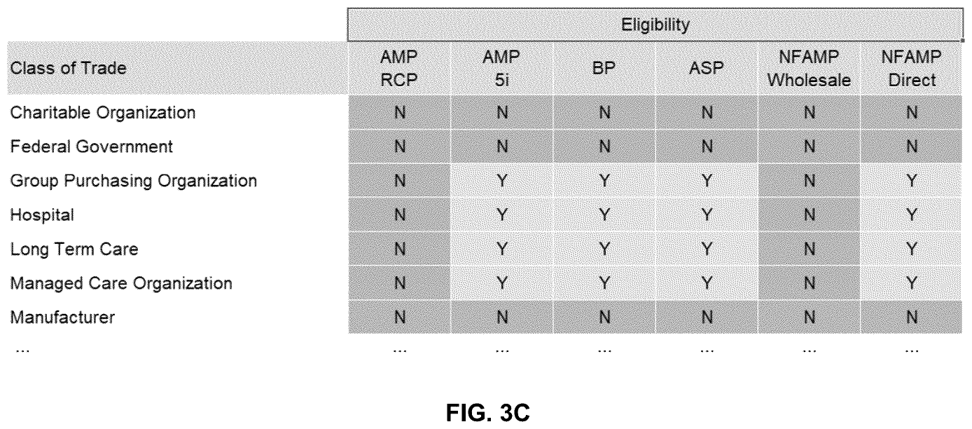

For example, FIG. 3A depicts how four different gating functions (i.e., gating functions for performing regulatory computation of average manufacturer price, “AMP,” best price, “BP,” average sales price, “ASP,” and non-federal average manufacturer price, “NFAMP”) could depend on the location of a transaction. In another example, FIG. 3B depicts how those four different gating functions could depend on the contract type of a transaction. Note that, in this example, calculation of those gating functions could include determining eligibility with respect to both properties, e.g., determining that a sample is eligible by determining that both its location and contract type properties correspond to at least one eligible category in the corresponding list of eligible categories (or, alternatively, determining that the particular sample is not eligible by determining that either of its location or contract type do not). In yet another example, FIG. 3C depicts how six different gating functions (four of which are sub-types of the four gating functions depicted in connection with FIGS. 3A and 3B) could depend on the type of entity to whom a drug was sold in a transaction.

Once the gating functions for a set of sample have been computed (and optionally, retrieved from storage for later use), those of the set of samples whose gating functions are positive can be used to perform a particular target calculation. Such a calculation could include a variety of mathematical operations, e.g., determining a running sum of one or more properties of the samples. For example, a running sum of transaction amounts, units per transaction, or some other property across the set of eligible samples. Such running sums (which may be weighted or non-weighted) could then be used as inputs some other operation. For example, an average price of a drug or class of drugs could be calculated by dividing a total transacted amount for the drug or class of drugs (optionally offset by one or more amounts related to, e.g., rebates, chargebacks, ineligible indirectly transacted units within a population of units originally transacted as part of eligible direct transaction) by a total number of units sold of the drug or class of drugs (optionally offset by one or more amounts related to, e.g., ineligible indirectly transacted units within a population of units originally transacted as part of eligible direct transaction).

Re-computing such a computation could include modifying one or more aspects of the computation. Such modifications can include applying a post-hoc adjustment to one or more intermediate results (e.g., a user-specified adjustment to a sum of transacted amounts, a sum of units transacted, a sum of rebates, a sum of chargebacks, or some other intermediate calculated amount). Such modifications can include applying a scaling or adjusting a weighting of one or more properties as they are applied to a calculation (e.g., changing a default price of a drug in transactions represented by eligible samples, changing an amount of a rebate received). Such modifications can include using a different calculation or eligibility type, e.g., performing a first calculation using a first pre-computed gating function and a second calculation using a second pre-computed gating function (which may, optionally, be the first pre-computed gating function). Such modifications can include performing the same calculation using the same pre-computed gating function across a different time range of samples (e.g., across a set of samples that correspond to a first year, quarter, or month and then across a set of samples that correspond to a different, optionally partially overlapping, second year, quarter, or month).

In some examples, a computation may involve performing separate sub-calculations on respective sets of eligible samples corresponding to respective different periods of time. For example, it could be desirable to determine, for a current or otherwise recent period of time (e.g., the immediately previous month, quarter, year), a calculation depending on both a first set of samples describing a first factor (e.g., the amounts and units sold of eligible direct sales of a pharmaceutical) and a second set of samples describing a second factor (e.g., the amounts of rebates, chargebacks, service fees, or other price modifications applied to sales of the pharmaceutical, or the amounts and units sold of ineligible indirect sales made downstream of the eligible direct sales). However, the samples of the second set could exhibit significant delays in acquisition (e.g., due to late reporting, due to latency in transmission, reporting, and/or ingestion of information), leading to difficulty in using the second set of sample to accurately estimate the second factor. In such examples, samples from a prior period of time (which may or may not overlap with the target period of time, but which at least partially precedes the target period of time) can be used to estimate the magnitude or other properties of the incomplete second set of samples in order to accomplish the desired calculation.

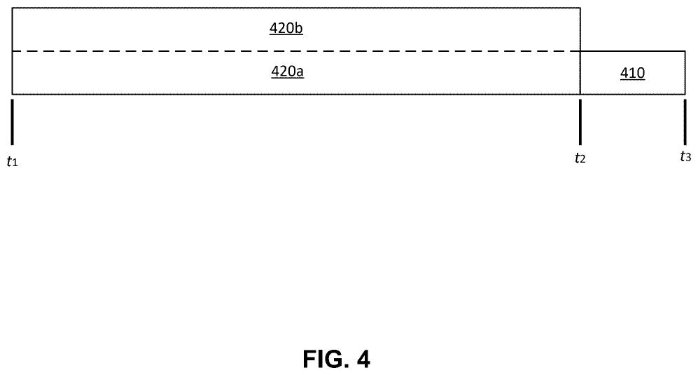

FIG. 4 depicts aspects of such a scenario, with a first set of samples 410 corresponding to a first period of time (t₂ to t₃) and representing a first aspect of a target calculation for the first period of time (e.g., amounts and units sold of eligible direct sales transactions). Second 420a and third 430b sets of samples corresponding to a second, preceding, period of time (t₁ to t₂) represent, respectively, the first aspect of a target calculation for the second period of time (e.g., amounts and units sold of eligible direct sales transactions) and a second aspect of the target calculation for the second period of time (e.g., amounts and units sold of ineligible indirect sales transactions downstream from eligible direct sales transactions for the second period of time and/or amounts of rebates, chargebacks, service fees, or other price modifications applied to the eligible direct sales transactions for the second period of time). The second 420a and third 430b sets of samples can be used to determine an expected ratio or other relationship between the first and second aspects of the target calculation for the second period of time and that ratio (or other relationship) can then be applied to the first set of samples 410 to estimate the second aspect of the target calculation for the first period of time and, thus, to accomplish the target calculation despite the lagging or otherwise incomplete nature of the available samples of the first period of time that correspond to the second factor.

For example, (i) a total number of units sold for eligible direct transactions could be determined for the second period of time based on the second set of samples 420a, (ii) a total number of units sold for ineligible indirect transactions downstream from the eligible direct transactions could be determined for the second period of time based on a portion of the third set of samples 420b, and (iii) a ratio between the total units number of units sold for the ineligible indirect transactions and the total number of units sold for eligible direct transactions could be determined for the second period of time. That ratio could then be used to estimate a total number of units sold for ineligible indirect transactions downstream from eligible direct transactions for the second period of time by (i) determining a total number of units sold for eligible direct transactions for the first period of time based on the first set of samples 410, and (ii) scaling the total number of units sold for eligible direct transactions by the ratio determined from the second period of time. The estimated total number of units sold for ineligible indirect transactions during the first period of time could then be used to perform some other calculation for the first period of time. For example, an average unit price for the first period of time could be determined by (i) offsetting the determined total number of units sold for eligible direct transactions for the first period of time by the estimated total number of units sold for ineligible indirect transactions during the first period of time, (ii) estimating a total amount paid for ineligible indirect transactions during the first period of time by multiplying the estimated total number of units sold for ineligible indirect transactions by a unit price, (iii) determining a total amount paid for eligible direct transactions during the first period of time based on the first set of samples 410, (iv) offsetting the total amount paid for eligible direct transactions by the estimated total amount paid for ineligible indirect transactions, and (v) subsequently determining an average price paid by dividing the offset total amount paid by the offset total number of units sold.

Additionally or alternatively, in another example, (i) a total amount of eligible direct transactions could be determined for the second period of time based on the second set of samples 420a, (ii) a total amount of rebates, chargebacks, service fees, or other price modifications applied to sales of eligible direct transactions could be determined for the second period of time based on a portion of the third set of samples 420b, and (iii) a ratio between the total amount of rebates, chargebacks, service fees, or other price modifications and the total amount of eligible direct transactions could be determined for the second period of time. That ratio could then be used to estimate a total amount of rebates, chargebacks, service fees, or other price modifications applied to sales of eligible direct transactions for the first period of time by (i) determining a total amount of eligible direct transactions for the first period of time based on the first set of samples 410, and (ii) scaling the total amount of eligible direct transactions by the ratio determined from the second period of time. The estimated total amount of rebates, chargebacks, service fees, or other price modifications during the first period of time could then be used to perform some other calculation for the first period of time. For example, an average unit price for the first period of time could be determined by (i) offsetting the determined total amount of eligible direct transactions for the first period of time by the estimated total amount of rebates, chargebacks, service fees, or other price modifications during the first period of time, and (ii) subsequently determining an average price paid by dividing the offset total amount paid (optionally further offset as above by the estimated amount of ineligible indirect downstream transactions) by the total number of units sold (optionally further offset as above by the estimated number of units sold as part of ineligible indirect downstream transactions).

A noted above, the embodiments described herein can result in significantly decreased latency and computational cost when performing a computation based on a set of samples for which gating function(s) have been pre-computed, potentially allowing a user to adjust aspects of the computation in substantially real-time. For example, a computation of average price of a unit of a drug could be calculated based on 600,000 samples (corresponding to transactions of various types, including sales, rebates, and chargebacks) using a personal computer in less than 170 milliseconds. These embodiments can also provide other technical benefits. For example, benefits with respect to the amount of storage space needed to provide an audit trail for one of the computations described herein. It is desirable in many applications to retain some or all of the intermediate results used to arrive at a target computation, e.g., to facilitate the creation of an audit trail to satisfy regulatory requirements and/or to prove to an auditor that previously-submitted final results were reasonably and accurately generated from a set of available data samples. However, the amount of such intermediate data can result in the storage and retention of untenably large amounts of data in order to facilitate such auditing or other activities. Instead, the pre-computed gating functions can be retained and stored as a smaller-size record of the underlying pattern of eligibility-determining properties (e.g., transaction location, transaction contract type, transaction customer identity or type, transacted drug ID or type), reducing the amount of storage space needed to retain sufficient amounts of intermediate results for a complete later audit of the downstream computation(s).

### II. Illustrative Systems

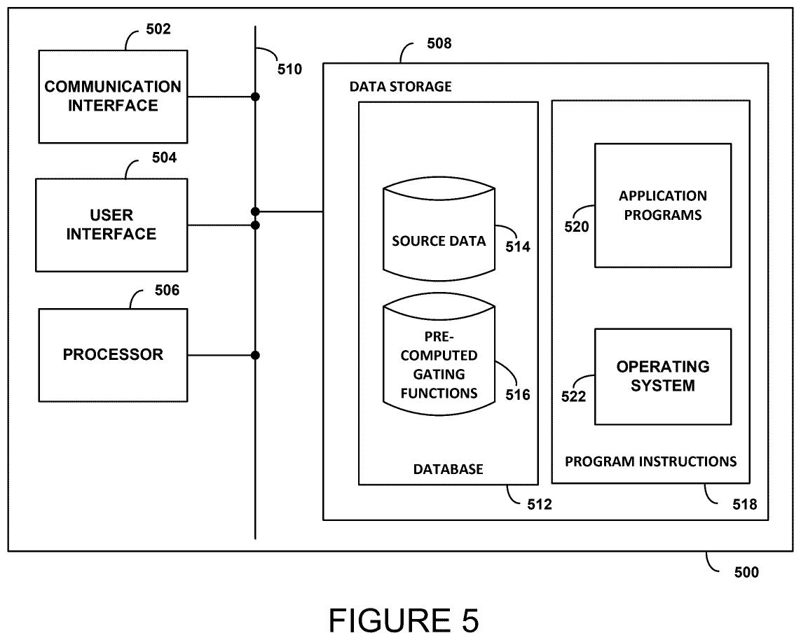

FIG. 5 illustrates an example computing system 500 that may be used to implement the methods described herein. By way of example and without limitation, computing system 500 may be a cellular mobile telephone (e.g., a smartphone), a computer (such as a desktop, notebook, tablet, or handheld computer, a server), elements of a cloud computing system, or some other type of device. It should be understood that computing system 500 may represent a physical computing device such as a server, a particular physical hardware platform on which an application operates in software, or other combinations of hardware and software that are configured to carry out calculation, database management/retrieval, or other functions as described herein. The computing system 500 could be a central system (e.g., a server, elements of a cloud computing system) that is configured to receive user inputs from a remote system and to responsively transmit, to that remote system or to some other system, the results of re-computed analyses or other computations specified by the user's inputs. Additionally or alternatively, the computing system 500 could be such a remote system, configured to transmit user inputs or other information to a central system, receive output analyses or other information in response, and/or to take some other actions as described herein.

As shown in FIG. 5, computing system 500 may include a communication interface 502, a user interface 504, a processor 506, and data storage 508, all of which may be communicatively linked together by a system bus, network, or other connection mechanism 510.

Communication interface 502 may function to allow computing system 500 to communicate, using analog or digital modulation of electric, magnetic, electromagnetic, optical, or other signals, with other devices, access networks, and/or transport networks. Thus, communication interface 502 may facilitate circuit-switched and/or packet-switched communication, such as Internet protocol (IP) or other packetized communication. For instance, communication interface 502 may include a chipset and antenna arranged for wireless communication with a radio access network or an access point. Also, communication interface 502 may take the form of or include a wireline interface, such as an Ethernet, Universal Serial Bus (USB), or High-Definition Multimedia Interface (HDMI) port. Communication interface 502 may also take the form of or include a wireless interface, such as a Wifi, BLUETOOTH®, global positioning system (GPS), or wide-area wireless interface (e.g., WiMAX or 3GPP Long-Term Evolution (LTE)). However, other forms of physical layer interfaces and other types of standard or proprietary communication protocols may be used over communication interface 502. Furthermore, communication interface 502 may comprise multiple physical communication interfaces (e.g., a Wifi interface, a BLUETOOTH® interface, and a wide-area wireless interface).

In some embodiments, communication interface 502 may function to allow computing system 500 to communicate with other devices, remote servers, access networks, and/or transport networks.

User interface 504 may function to allow computing system 500 to interact with a user or other entity, for example to receive input from and/or to provide output to the user. Thus, user interface 504 may include input components such as a keypad, keyboard, touch-sensitive or presence-sensitive panel, computer mouse, trackball, joystick, microphone, and so on. User interface 504 may also include one or more output components such as a display screen which, for example, may be combined with a presence-sensitive panel. The display screen may be based on CRT, LCD, and/or LED technologies, or other technologies now known or later developed. User interface 504 may also be configured to generate audible output(s), via a speaker, speaker jack, audio output port, audio output device, earphones, and/or other similar devices.

Processor 506 may comprise one or more general purpose processors—e.g., microprocessors—and/or one or more special purpose processors—e.g., digital signal processors (DSPs), graphics processing units (GPUs), floating point units (FPUs), network processors, tensor processing units (TPUs), or application-specific integrated circuits (ASICs). Data storage 508 may include one or more volatile and/or non-volatile storage components, such as magnetic, optical, flash, or organic storage, and may be integrated in whole or in part with processor 506. Data storage 508 may include removable and/or non-removable components.

Processor 506 may be capable of executing program instructions 518 (e.g., compiled or non-compiled program logic and/or machine code) stored in data storage 508 to carry out the various functions described herein. Therefore, data storage 508 may include a non-transitory computer-readable medium, having stored thereon program instructions that, upon execution by computing system 500, cause computing system 500 to carry out any of the methods, processes, or functions disclosed in this specification and/or the accompanying drawings. The execution of program instructions 518 by processor 506 may result in processor 506 using data that is, e.g., organized in a database 512.

By way of example, program instructions 518 may include an operating system 522 (e.g., an operating system kernel, device driver(s), and/or other modules) and one or more application programs 520 (e.g., functions for performing one or more of the methods described herein) installed on computing system 500. Database 512 may include source data (e.g., data about physical measurements or other samples that represent physical variables in the world, data about a set of transactions, e.g., of pharmaceuticals, or some other data) 514 and/or pre-computed gating function(s) 516 that may be determined therefrom or obtained in some other manner.

Application programs 520 may communicate with operating system 522 through one or more application programming interfaces (APIs). These APIs may facilitate, for instance, application programs 520 transmitting or receiving information via communication interface 502, receiving and/or displaying information on user interface 504, and so on.

Application programs 520 may take the form of “apps” that could be downloadable to computing system 500 through one or more online application stores or application markets (via, e.g., the communication interface 502). However, application programs can also be installed on computing system 500 in other ways, such as via a web browser or through a physical interface (e.g., a USB port) of the computing system 500.

### III. Example Methods

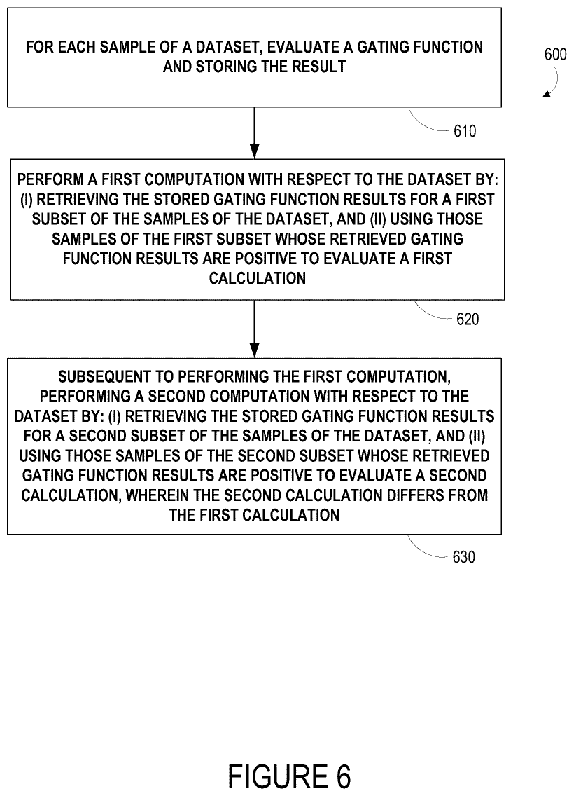

FIG. 6 is a flowchart of an example computer-implemented method 600 for efficiently re-executing computations on large datasets. The method 600 includes, for each sample of a dataset, evaluating a gating function and storing the result (610). The method 600 additionally includes performing a first computation with respect to the dataset by: (i) retrieving the stored gating function results for a first subset of the samples of the dataset, and (ii) using those samples of the first subset whose retrieved gating function results are positive to evaluate a first calculation (620). The method 600 additionally includes, subsequent to performing the first computation, performing a second computation with respect to the dataset by: (i) retrieving the stored gating function results for a second subset of the samples of the dataset, and (ii) using those samples of the second subset whose retrieved gating function results are positive to evaluate a second calculation, wherein the second calculation differs from the first calculation (630). The method 600 could include additional or alternative features.

### VI. Conclusion

The particular arrangements shown in the Figures should not be viewed as limiting. It should be understood that other embodiments may include more or less of each element shown in a given Figure. Further, some of the illustrated elements may be combined or omitted. Yet further, an exemplary embodiment may include elements that are not illustrated in the Figures.

Additionally, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

What is claimed is:

1. A method for efficiently re-executing computations on large datasets, the method including:
for each sample of a dataset, evaluating a gating function and storing the result;
performing a first computation with respect to the dataset, wherein performing the first computation with respect to the dataset comprises:
retrieving the stored gating function results for a first subset of the samples of the dataset, and
using those samples of the first subset whose retrieved gating function results are positive to evaluate a first calculation; and
subsequent to performing the first computation, performing a second computation with respect to the dataset, wherein performing the second computation with respect to the dataset comprises:
retrieving the stored gating function results for a second subset of the samples of the dataset, and
using those samples of the second subset whose retrieved gating function results are positive to evaluate a second calculation, wherein the second calculation differs from the first calculation.

2. The method of claim 1, wherein evaluating the gating function for a particular sample of the dataset comprises evaluating the gating function with respect to two or more properties of the particular sample.

3. The method of claim 2, wherein evaluating the gating function with respect to two or more properties of the particular sample comprises evaluating whether each of the two or more properties match respective two or more specified conditions.

4. The method of claim 3, wherein each of the two or more properties of the particular sample are categorical variables, and wherein evaluating whether each of the two or more properties match respective two or more specified sets of categorical variable categories.

5. The method of claim 4, wherein the two or more properties of the particular sample represent at least two of a location of a transaction, a contract type of a transaction, an identity of a drug sold in a transaction, or a type of entity to whom a drug was sold in a transaction.

6. The method of claim 1, wherein retrieving the stored gating function results for the first subset comprises retrieving the stored gating function results for a subset of the samples of the dataset having a time property within a specified first time period.

7. The method of claim 6, wherein retrieving the stored gating function results for the subset of samples of the dataset having a time property within the specified first time period comprises evaluating whether the time property of each sample in the first subset has a value within the first time period.

8. The method of claim 6, wherein performing the first computation with respect to the dataset further comprises:
retrieving the stored gating function results for third subset of the samples of the dataset having a time property within a specified second time period that differs from and at least partially precedes the first time period,
using those samples of the third subset whose retrieved gating function results are positive to evaluate a first offset calculation, and
offsetting the result of the first calculation by the result of the first offset calculation.

9. The method of claim 8, wherein evaluating the first offset calculation comprises (i) determining a ratio between a sum of a first population of the samples of the third subset and a sum of a second population of the samples of the third subset, wherein the first and second populations of samples of the third subset do not overlap, and (ii) scaling the result of the first calculation by the ratio to generate the result of the first offset calculation.

10. The method of claim 8,
wherein evaluating the first calculation comprises determining (i) a first sum of transaction amounts of transactions represented by samples of the first subset whose retrieved gating function results are positive and (ii) a first sum of units sold as part of the transactions represented by samples of the first subset whose retrieved gating function results are positive,
wherein evaluating the first offset calculation comprises determining (i) a second sum of units sold as part of ineligible indirect transactions represented by samples of the third subset whose retrieved gating function results are positive, (ii) a third sum of units sold as part of direct transactions represented by samples of the third subset whose retrieved gating function results are positive, (iii) a first ratio between the second sum of units sold and the third sum of units sold, and (iv) scaling the first sum of units sold by the first ratio to generate an offset number of units sold,
wherein offsetting the result of the first calculation by the result of the first offset calculation comprises:
offsetting the first sum of units sold by the offset number of units sold, and
offsetting the first sum of transaction amounts by a product of the offset number of units sold and a unit price, and
wherein performing the first computation with respect to the dataset further comprises determining a second ratio between (i) the first sum of transaction amounts offset by a product of the offset number of units sold and a unit price and (ii) the first sum of units sold offset by the offset number of units sold.

11. The method of claim 10, wherein performing the first computation with respect to the dataset further comprises:
retrieving the stored gating function results for a fourth subset of the samples of the dataset having a time property within the specified second time period,
determining a first sum of transaction offset amounts of transaction offsets represented by samples of the fourth subset whose retrieved gating function results are positive,
determining a second sum of transaction amounts of transactions represented by samples of the fourth subset whose retrieved gating function results are positive,
determining a third ratio between the first sum of transaction offset amounts and the second sum of transaction amounts, and
prior to determining the second ratio, further offsetting the first sum of transaction amounts by the offset first sum of transaction amounts scaled by the third ratio.

12. The method of claim 10, wherein performing the second computation comprises at least one of:
evaluating the second calculation by determining a sum of transaction amounts of transactions represented by samples of the first subset whose retrieved gating function results are positive, adjusted by a user-specified amount; or
evaluating the second calculation by determining a sum of units sold as part of the transactions represented by samples of the first subset whose retrieved gating function results are positive, adjusted by a user-specified amount.

13. The method of claim 1, wherein the first subset of samples and second subset of samples encompass the same subset of the samples of the dataset, wherein evaluating the first calculation comprises determining a first weighted sum of a first property of samples of the first subset, and wherein evaluating the second calculation comprises at least one of: (i) determining a second weighted sum of the first property of samples of the second subset, wherein a weighting applied to the first property of samples of the second dataset to generate the second weighted sum differs from a weighting applied to the first property of samples of the first dataset to generate the first weighted sum, or (ii) determining a third weighted sum of the first property of samples of the second subset and adjusting the third weighted sum by a user-specified amount.

14. The method of claim 1, wherein the first subset of samples and second subset of samples encompass different subsets of the samples of the dataset.

15. The method of claim 1, further comprising:
for each sample of the dataset, evaluating a second gating function and storing the result; and
performing a third computation with respect to the dataset, wherein performing the third computation with respect to the dataset comprises:
retrieving the stored second gating function results for the first subset of the samples of the dataset, and
using those samples of the first subset whose retrieved second gating function results are positive to evaluate the first calculation.

16. The method of claim 15, wherein each sample of the first subset has a respective set of at least one categorical gating properties, wherein evaluating the gating function for a particular sample of the first subset comprises determining whether each categorical gating property of the particular sample matches a corresponding set of eligible categories of the gating function, wherein evaluating the second gating function for the particular sample of the first subset comprises determining whether each categorical gating property of the particular sample matches a corresponding set of eligible categories of the second gating function, wherein the gating function and second gating function differ with respect to at least one set of eligible categories, and wherein the set of at least one categorical gating properties comprises at least one of a transaction location, a transaction contract type, a transacted drug identity, and a transaction customer type.

17. The method of claim 1, wherein the samples of the dataset are stored in a first set of one or more tables of a database, wherein storing the result of the evaluation of the gating function comprises storing the result of the evaluation of the gating function in a second set of one or more tables of the database, wherein the database is configured according to a star schema, and wherein the first set of one or more tables are fact tables, and wherein the second set of one or more tables are dimension tables.

18. The method of claim 1, further comprising:
subsequent to performing the first computation, obtaining an update to a particular sample of the dataset that is within the second subset; and
evaluating the gating function with respect to the updated particular sample and storing the updated result, wherein retrieving the stored gating function results for the second subset comprises retrieving the stored updated result for the particular sample.

19. A non-transitory computer readable medium having stored thereon program instructions executable by at least one processor to cause the at least one processor to perform operations comprising:
for each sample of a dataset, evaluating a gating function and storing the result;
performing a first computation with respect to the dataset, wherein performing the first computation with respect to the dataset comprises:
retrieving the stored gating function results for a first subset of the samples of the dataset, and
using those samples of the first subset whose retrieved gating function results are positive to evaluate a first calculation; and
subsequent to performing the first computation, performing a second computation with respect to the dataset, wherein performing the second computation with respect to the dataset comprises:
retrieving the stored gating function results for a second subset of the samples of the dataset, and
using those samples of the second subset whose retrieved gating function results are positive to evaluate a second calculation, wherein the second calculation differs from the first calculation.

20. A system comprising:
at least one processor; and
a non-transitory computer-readable medium, having stored therein instructions executable by the at least one processor to cause the system to perform operations comprising:
for each sample of a dataset, evaluating a gating function and storing the result;
performing a first computation with respect to the dataset, wherein performing the first computation with respect to the dataset comprises:
retrieving the stored gating function results for a first subset of the samples of the dataset, and
using those samples of the first subset whose retrieved gating function results are positive to evaluate a first calculation; and
subsequent to performing the first computation, performing a second computation with respect to the dataset, wherein performing the second computation with respect to the dataset comprises:
retrieving the stored gating function results for a second subset of the samples of the dataset, and
using those samples of the second subset whose retrieved gating function results are positive to evaluate a second calculation, wherein the second calculation differs from the first calculation.
